(19) United States
(12) Patent Application Publication
(10) Pub. No.: US 2012/0327679 A1
(43) Pub. Date: Dec. 27, 2012

(54) LIGHT EMITTING DEVICE, HEADLIGHT FOR A VEHICLE, AND ILLUMINATION DEVICE

(75) Inventor: Koji TAKAHASHI, Osaka-shi (JP)

(73) Assignee: Sharp Kabushiki Kaisha, Osaka-shi (JP)

(21) Appl. No.: 13/485,495

(22) Filed: May 31, 2012

(30) Foreign Application Priority Data
Jun. 21, 2011 (JP) 2011-137852

(51) Int. Cl. B60Q 1/04; F21V 13/08; F21V 9/16

(52) U.S. Cl. 362/538; 362/84

(57) ABSTRACT

A head lamp 1 includes a light emitting section 4 for emitting light upon receipt of laser light emitted from a laser element 2. A position on the light emitting section 4 which position is irradiated with the laser light can be changed by changing a location or an angle where the light emitting section 4 is provided.

This Nonprovisional application claims priority under 35 U.S.C. §119 on Patent Application No. 2011-137852 filed in Japan on Jun. 21, 2011, the entire contents of which are hereby incorporated by reference.

### TECHNICAL FIELD

The present invention relates to a light emitting device, a headlight for a vehicle and an illumination device, which can suppress deteriorations of their respective light emitting sections.

### BACKGROUND ART

Recently, a light emitting device has been widely researched, which uses a semiconductor light emitting element, such as an LED (Light Emitting Diode) or a LD (Laser Diode), as an excitation light source. In the light emitting device, a light emitting section containing a fluorescent material is irradiated with excitation light generated by the excitation light source so as to emit incoherent illumination light.

Patent literature 1, for example, discloses such a technology relating to the above-mentioned light emitting device.

A light source device of Patent literature 1 includes a laser diode for emitting short-wavelength laser light, a collimator lens for transforming the laser light emitted from the laser diode into a bundle of parallel rays, a condenser for converging the bundle of parallel rays of the laser light, and a fluorescent material for absorbing the laser light converged by the condenser and emitting spontaneous emission light. According to the light source device of Patent literature 1, the fluorescent material absorbs laser light having a high light intensity so as to spontaneously emit fluorescence.

Patent literatures 2 through 4 disclose, as light sources for generating light, fluorescent materials for emitting light in accordance with externally radiated light.

### CITATION LISTS

### Patent Literatures

Patent literature 1
Japanese Patent Application Publication, No. Tokukai, 2003-295319 A (Publication Date: Oct. 15, 2003)
Patent literature 2
Japanese Patent Application Publication, No. Tokukai, 2004-241142 A (Publication Date: Aug. 26, 2004)
Patent literature 3
Japanese Patent Application Publication, No. Tokukai, 2005-150041 A (Publication Date: Jun. 9, 2005)
Patent literature 4
Japanese Patent Application Publication, No. Tokukai, 2011-060884 A (Publication Date: Mar. 24, 2011)

### SUMMARY OF INVENTION

### Technical Problem

However, the conventional technologies cause following problems.

According to a projector of Patent literature 1 which utilizes light emitted from a light emitting section, by exciting, with the use of the laser light or the like, a fluorescence section provided near a focal point of a reflecting mirror (a reflector), the fluorescence section is more likely to deteriorate near a focal point where the radiation of the laser light is concentrated. The deterioration of the fluorescence section causes a reduction in light intensity of the fluorescence emitted from the fluorescence section. None of Patent literatures 2 through 4 discloses a configuration in which a position on the fluorescent material which position is excited by laser can be changed, for example, by exchanging the fluorescent material or by changing an angle where the fluorescent material is provided.

The present invention has been accomplished in view of the problem, and an object of the present invention is to provide a light emitting device, a headlight for a vehicle and an illumination device, which can suppress deteriorations of respective light emitting sections.

### Solution to Problem

In order to solve the above-mentioned problem, a light emitting device in accordance with the present invention includes a light emitting section for emitting light upon receipt of excitation light from an excitation light source, the light emitting section being provided so as to be replaceable with a new one.

According to the light emitting device of the present invention, the light emitting section is provided so as to be replaceable with a new one.

In the light emitting device in accordance with the present invention, therefore, it is possible to suppress deterioration of the light emitting section by changing a position on the light emitting section which position is irradiated with the excitation light before the light emitting section begins to deteriorate or on the occasion when the least performance degradation of the light emitting device is acknowledged.

In order to solve the above-mentioned problem, a light emitting device in accordance with the present invention includes a light emitting section for emitting light upon receipt of excitation light from an excitation light source, a position on the light emitting section which position is irradiated with the excitation light being changed by changing a location or an angle where the light emitting section is provided.

Generally, a light emitting section is most strongly excited in a part in a focal point of a reflecting mirror. Accordingly, in a case where a conventional light emitting device is used over an extended period of time, the light emitting section is more likely to deteriorate in and near the focal point. A conventional light emitting device, in which a light emitting section is generally fixedly integrated, cannot deal with deterioration of the light emitting section. As a result, the conventional light emitting device is not suited for use over an extended period of time.

In contrast, in the light emitting device in accordance with the present invention, a position on the light emitting section which position is irradiated with the excitation light is changed by changing a location or an angle where the light emitting section is provided.

Accordingly, in the light emitting device in accordance with the present invention, it is possible to suppress deterioration of the light emitting section by changing a position on the light emitting section which position is irradiated with excitation light before the light emitting section begins to deteriorate or on the occasion when the least performance degradation of the light emitting device is acknowledged. This makes it possible to extend the estimated usable period of the light emitting section, so that the light emitting device in accordance with the present invention can be used over an extended period of time.

In the light emitting device in accordance with the present invention, the irradiated position can be changed by changing a location where the light emitting section is provided. In other words, since the light emitting device in accordance with the present invention has a plurality of mounting locations of the light emitting section, it is therefore possible to change the irradiated position. Alternatively, in the light emitting device in accordance with the present invention, the irradiated position can be changed by changing an angle where the light emitting section is provided. In other words, since the light emitting device in accordance with the present invention has a configuration in which a mounting angle can be changed, it is therefore possible to change the irradiated position.

Consequently, the light emitting device in accordance with the present invention can attain a longer operating life with a very simple configuration.

### Advantageous Effects of Invention

As described above, the light emitting device in accordance with the present invention includes a light emitting section for emitting light upon receipt of excitation light from an excitation light source, the light emitting section being provided so as to be replaceable with a new one.

As described above, the light emitting device in accordance with the present invention includes a light emitting section for emitting light upon receipt of excitation light from an excitation light source, a position on the light emitting section which position is irradiated with the excitation light being changed by changing a location or an angle where the light emitting section is provided.

The light emitting device in accordance with the present invention therefore has an effect that deterioration of the light emitting section can be suppressed.

### BRIEF DESCRIPTION OF DRAWINGS

FIG. 1

FIG. 1 is a cross-sectional view schematically illustrating a configuration of a head lamp in accordance with an embodiment of the present invention.

FIG. 2

FIG. 2 is a top view schematically illustrating the head lamp of FIG. 1.

FIG. 3

FIG. 3 is a conceptual diagram illustrating a rotary paraboloid of a parabolic mirror.

FIG. 4

FIG. 4(a) is a top view illustrating the parabolic mirror. FIG. 4(b) is a front view illustrating the parabolic mirror. FIG. 4(c) is a side view illustrating the parabolic mirror.

FIG. 5

FIG. 5 is a conceptual diagram illustrating a direction in which a head lamp is arranged in an automobile.

FIG. 6

(a) through (d) of FIG. 6 are top views schematically illustrating another head lamp in accordance with the present embodiment. (a) of FIG. 6 illustrates a situation in which the head lamp is arranged in a first location. (b) of FIG. 6 illustrates a situation in which the head lamp is arranged in a second location. (c) of FIG. 6 illustrates a situation in which the head lamp is arranged in a third location. (d) of FIG. 6 illustrates a situation in which the head lamp 200 is arranged in a fourth location.

FIG. 7

(a) and (b) of FIG. 7 are diagrams illustrating how to mount a light emitting section on a metal base. (a) of FIG. 7 illustrates a configuration in which the light emitting section is mounted in a first location of the metal base. (b) of FIG. 7 illustrates a configuration in which the light emitting section is mounted in a second location of the metal base.

FIG. 8

(a) through (d) of FIG. 8 are diagrams illustrating how to change an angle where a light emitting section is provided.

FIG. 9

FIG. 9 is a top view schematically illustrating yet another head lamp in accordance with the present embodiment.

FIG. 10

FIG. 10 is a side view schematically illustrating the head lamp in accordance with the present embodiment.

FIG. 11

FIG. 11 is a top view schematically illustrating yet another head lamp in accordance with the present embodiment.

FIG. 12

FIG. 12 is a top view schematically illustrating yet another head lamp in accordance with the present embodiment.

FIG. 13

FIG. 13 is a diagram illustrating a crank mechanism for causing a light emitting section of the head lamp in accordance with the present embodiment to reciprocate.

FIG. 14

FIG. 14 is a side view schematically illustrating a reflective head lamp.

FIG. 15

FIG. 15 is a side view schematically illustrating a transmissive head lamp.

FIG. 16

FIG. 16 is a side view schematically illustrating a reflective head lamp which uses no metal member.

FIG. 17

FIG. 17 is a side view schematically illustrating a transmissive head lamp which uses no transparent member.

FIG. 18

FIG. 18 is a side view illustrating yet another head lamp in accordance with the present embodiment.

FIG. 19

FIG. 19 is a top view schematically illustrating the yet another head lamp in accordance with the present embodiment in which a light emitting section is irradiated, from three directions, with laser light emitted by laser elements.

FIG. 20

FIG. 20 illustrates that a metal member on which upper part a light emitting section is applied is attached to a metal base.

FIG. 21

FIG. 21 illustrates that the metal member is detached from the metal base.

FIG. 22

FIG. 22 illustrates how to replace a light emitting section with a new one via screws.

FIG. 23

FIG. 23 illustrates how to replace a light emitting section with a new one by being fitted into a metal base.

FIG. 24

FIG. 24 illustrates how to replace a light emitting section, provided with the use of springs, with a new one.

FIG. 25

FIG. 25 is a top view schematically illustrating yet another head lamp in accordance with the present embodiment.

### DESCRIPTION OF EMBODIMENTS

With reference to the attached drawings, the following description will discuss a head lamp 1 and other components in accordance with the present embodiment. Note that the following description will mainly address the head lamp, however, the head lamp is merely an example of an illumination device to which the present invention can be applied. Therefore, the present application is, of causes, applicable to any illumination device. In the following description, the same reference numerals are given to the same members and components which have the respective same names and functions. Accordingly, their detailed descriptions will be omitted.

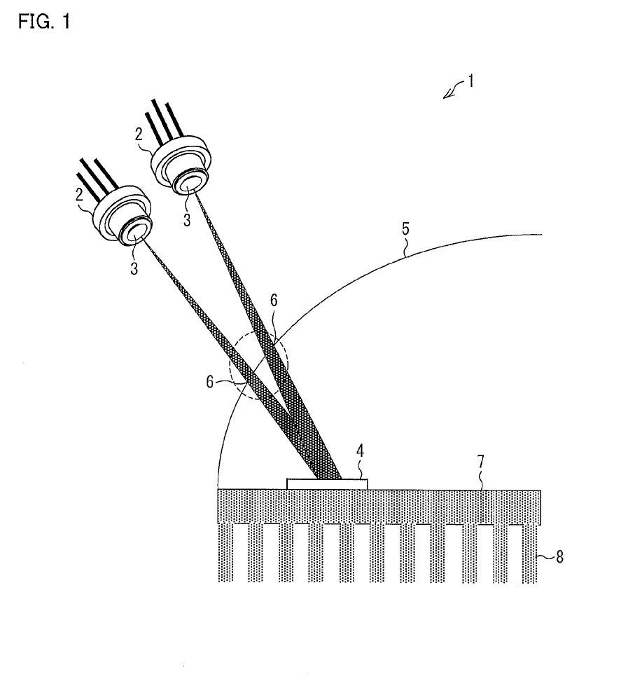

The following description will discuss an embodiment of the present invention with reference to FIG. 1 and other drawings.

[Configuration of Head Lamp 1]

FIG. 1 is a cross-sectional view schematically illustrating a configuration of a head lamp 1 in accordance with an embodiment of the present invention. As illustrated in FIG. 1, the head lamp 1 includes: a laser element (excitation light source) 2; a lens 3; a light emitting section 4; a parabolic mirror (reflecting mirror) 5; a metal base 7, and a fin 8.

### (Laser Element 2)

The laser element 2 is a light emitting element which acts as an excitation light source for emitting excitation light. There can be provided a plurality of the laser elements 2, instead of a single laser element 2. In this case, each of the plurality of the laser elements 2 outputs laser light serving as excitation light. A single laser element 2 can be used, instead of a plurality of laser elements 2. It is, however, easier to obtain high output laser light when a plurality of laser elements 2 are used than when such a single laser element 2 is used.

The laser element 2 can be a laser element having one light emitting point per chip or a laser element having a plurality of light emitting points per chip. The wavelength of the laser light of the laser element 2 is, for example, 405 nm (blue-violet) or 450 nm (blue). Note, however, that the wavelength is not limited to this, and can therefore be appropriately selected in accordance with the type of a fluorescent material contained in the light emitting section 4.

Instead of the laser element, a light emitting diode (LED) can be used as an excitation light source.

### (Lens 3)

The lens 3 is to adjust (enlarge, for example) an irradiation range of laser light emitted from the laser element 2 so that the light emitting section 4 is appropriately irradiated with the laser light. Each laser element 2 is provided with a lens 3.

### (Light Emitting Section 4)

The light emitting section 4 contains a fluorescent material for emitting light upon receipt of laser light. As such, the light emitting section 4 emits fluorescence upon receipt of the laser light from the laser element 2. Specifically, the light emitting section 4 is obtained (i) by dispersing a fluorescent material into a sealing material or (ii) by solidifying a fluorescent material. Since the light emitting section 4 converts laser light into fluorescence, it can be regarded as a wavelength conversion element.

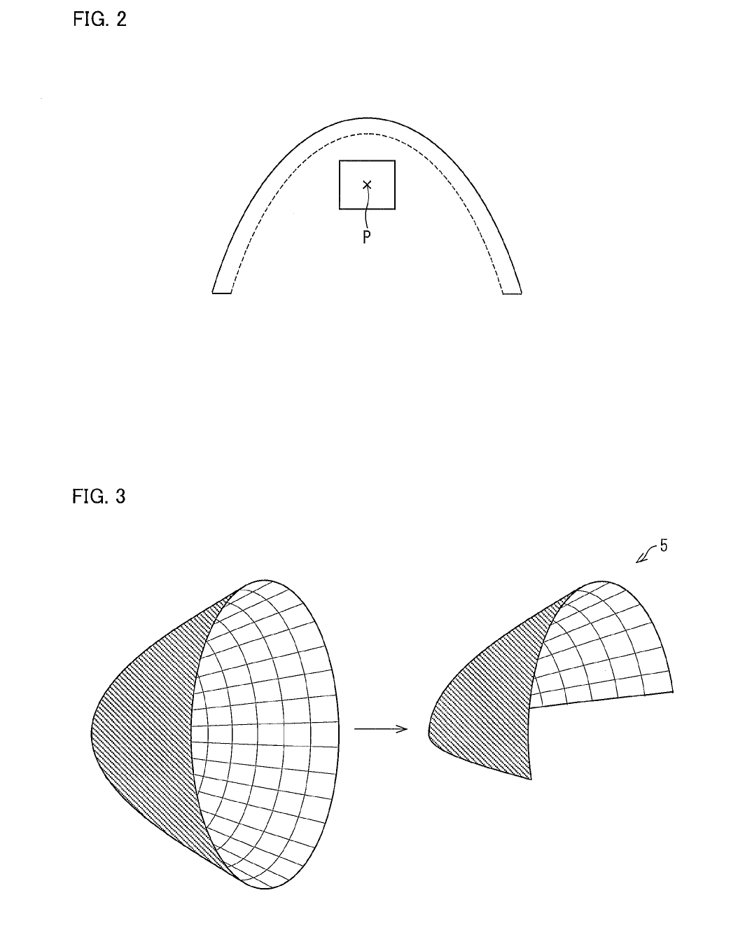

The light emitting section 4 is provided on the metal base 7 so that a focal point of the parabolic mirror 5 is located in the light emitting section 4 (see FIG. 2). FIG. 2 is a top view schematically illustrating the head lamp 1 of FIG. 1. As illustrated in FIG. 2, the light emitting section 4 is provided on the metal base 7 so that the focal point (the point P in FIG. 2) of the parabolic mirror 5 is located in the light emitting section 4. Therefore, the fluorescence emitted from the light emitting section 4 is reflected by a curved reflecting surface of the parabolic mirror 5, so that a light path of the fluorescence is controlled.

Examples of the fluorescent material of the light emitting section 4 can encompass an oxynitride fluorescent material (such as a sialon fluorescent material) and a III-V compound semiconductor nanoparticle fluorescent material (such as indium phosphate: InP). The fluorescent materials are most suitable for a laser illumination light source. This is because they have high resistance to heat caused by the high output (and/or high light density) laser light emitted from the laser element 2. Note, however, that the fluorescent material of the light emitting section 4 is not limited to the above materials, and can therefore be other fluorescent materials such as a nitride fluorescent material.

Further, it is stipulated in the law that illumination light of head lamps should be white having a predetermined range of chroma. In conformity with the law, the light emitting section 4 contains a fluorescent material(s) selected so as to emit white illumination light.

For example, a light emitting section 4 containing blue, green, and red fluorescent materials is irradiated with laser light of 405 nm, so as to emit white light. Alternatively, a light emitting section 4 containing a yellow fluorescent material (or green and red fluorescent materials) is irradiated with laser light of 450 nm (blue) (or so-cold near blue laser light having a peak wavelength in a wavelength range from equal or not less than 440 nm to equal or not more than 490 nm), so as to emit white light.

Examples of the sealing material of the light emitting section 4 encompass a resin material such as a glass material (inorganic glass or organic/inorganic hybrid glass) and silicone resin. A low-melting glass can be used as the glass material. The sealing material preferably has high transparency, and high heat resistance in case of high output laser light.

(Reflecting mirror (Parabolic Mirror 5))

The parabolic mirror 5 reflects the fluorescence generated by the light emitting section 4 so as to form a bundle of rays (illumination light) which travels within a predetermined solid angle. Examples of the parabolic mirror 5 encompass (a) a member which is coated with a metal thin film and (b) a member made from metal.

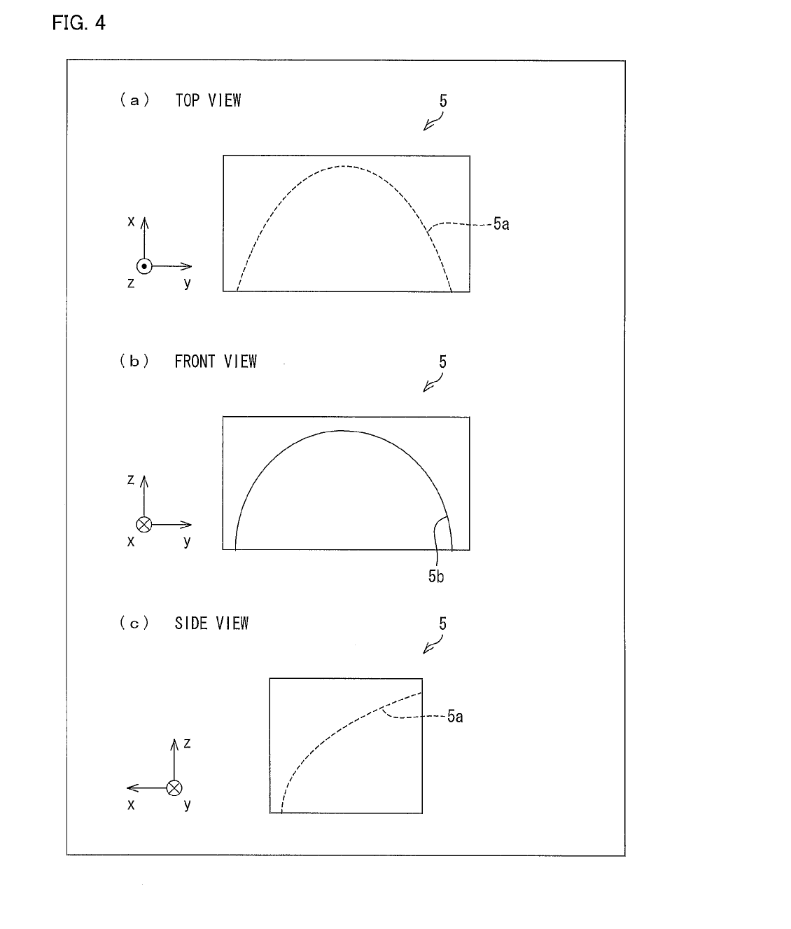

FIG. 3 is a conceptual diagram illustrating a rotary paraboloid of the parabolic mirror 5. FIG. 4(a) is a top view illustrating the parabolic mirror 5, FIG. 4(b) is a front view illustrating the parabolic mirror 5, and FIG. 4(c) is a side view illustrating the parabolic mirror 5. FIGS. 4(a) through 4(c) illustrate an example of the parabolic mirror 5 prepared by hollowing the rectangular solid member, in order to make illustration clearly understandable.

As illustrated in FIG. 3, at least part of a partial curved-surface is part of a reflection surface of the parabolic mirror 5. The partial curved-surface is obtained by cutting off a curved-surface (parabolic curved-surface), which is formed by rotating a parabola around an axis of symmetry (a rotation axis) of the parabola, so that a plane containing the rotation axis becomes a cut surface. In FIGS. 4(a) and 4(c), a curve indicated by a reference numeral 5a is the parabolic curved-surface. When the parabolic mirror 5 is viewed from the front side, an opening 5b (exit of illumination light) of the parabolic mirror 5 is in a shape of a half circle (see FIG. 4(b)).

Further, the laser element 2 is provided outside the parabolic mirror 5, and the parabolic mirror 5 has a window(s) 6 through which laser light is transmitted or passes. The window(s) 6 can be an opening or can be made from a transparent member through which laser light can be transmitted. For example, a transparent plate including a filter by which laser light is transmitted and which reflects white light (fluorescence of the light emitting section 4) can be employed as the window 6. This can prevent fluorescence generated by the light emitting section 4 from leaking from the window 6.

A single window 6 can be provided for a plurality of laser elements 2. Alternatively, a plurality of windows 6 can be provided for the respective plurality of laser elements 2.

The parabolic mirror 5 can partially have a non-parabolic part. And, the reflecting mirror can be (i) a parabolic mirror having an opening in a shape of a closed circle or (ii) a part of the parabolic mirror. Note that the reflecting mirror is not limited to the parabolic mirror, and can therefore be an ellipsoidal mirror or a free-form curved-surface mirror. That is, the reflecting mirror is not limited to a specific one, provided that at least part of a curved-surface formed by rotating a graphic (ellipsoid, circle, or parabola) around a rotation axis is a part of a reflection surface of the reflecting mirror.

### (Metal Base 7)

The metal base 7 is a support member having a plate shape for supporting the light emitting section 4. The metal base 7 is made from metal (such as copper or iron), and therefore has high thermal conductivity and is capable of effectively radiating heat caused by the light emitting section 4. Note that the member for supporting the light emitting section 4 is not limited to a member made from metal, and can be any member which contains a material (such as glass or sapphire) other than metal, the material having a high thermal conductivity. Note, however, that it is preferable that a surface of the metal base 7, which surface abuts the light emitting section 4, acts as a reflecting surface. The surface acting as a reflecting surface allows laser light, which has entered from the top of the emitting section 4, (i) to be converted into fluorescence and then (ii) to be reflected by the reflecting surface so as to be directed toward the parabolic mirror 5. Alternatively, the surface acting as the reflecting surface allows laser light, which has entered from the top of the light emitting section 4, to be reflected by the reflecting surface so as to be directed inward of the light emitting section 4. This allows a conversion into fluorescence.

The metal base 7 is covered with the parabolic mirror 5. It follows that the metal base 7 has a surface facing the curved reflecting surface (parabolic curved-surface) of the parabolic mirror 5. It is preferable that a surface of the metal base 7, on which surface the light emitting section 4 is provided, (i) is substantially parallel to the rotation axis of the rotary paraboloid of the parabolic mirror 5 and (ii) substantially include the rotation axis.

### (Fin 8)

The fin 8 acts as a cooling section (heat radiation mechanism) for cooling down the metal base 7. The fin 8 is made up of a plurality of heatsinks. A heat radiation efficiency of the fin 8 is improved by increasing an area where the metal base 7 comes into contact with air. The cooling section for cooling the metal base 7 is not limited to a specific one, provided that it has a cooling (heat radiation) function, and can therefore be a heat pipe, a water-cooled system, or an air-cooled system.

### [How to Arrange the Head Lamp 1]

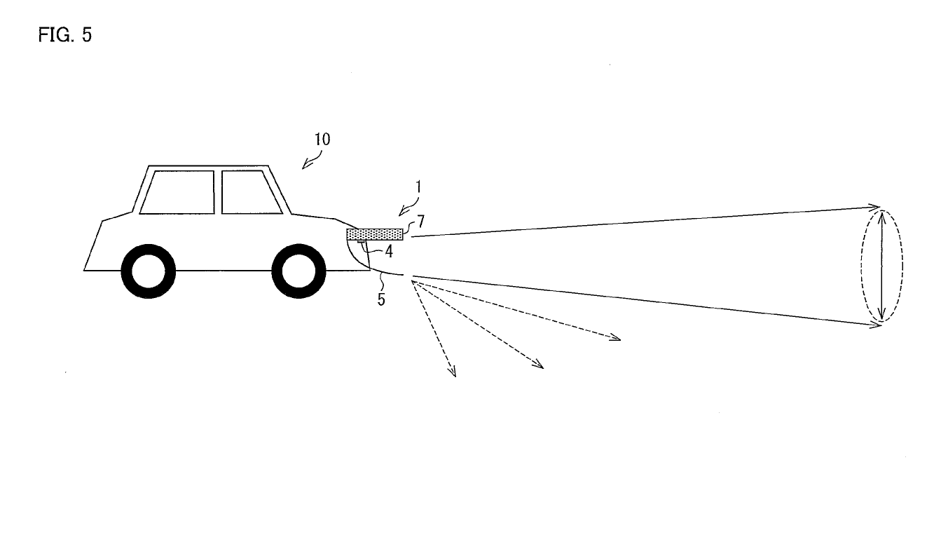

FIG. 5 is a conceptual diagram illustrating a direction in which the head lamp 1 is arranged, in a case where the head lamp 1 is applied to a headlight of an automobile (vehicle) 10. As illustrated in FIG. 5, the head lamp 1 can be arranged in a head part of the automobile 10 such that the parabolic mirror 5 is located vertically downward. With the arrangement, due to the foregoing projecting characteristic of the parabolic mirror 5, not only the forward of the automobile 10 is brightly illuminated but also lower forward of the automobile 10 is illuminated to some extent.

The head lamp 1 can be applied to a driving headlight (high beam) of or a dipped-beam headlight (low beam) of an automobile. Alternatively, it is possible, during driving of the automobile 10, to control optical power distribution of laser light with which an irradiation surface of the light emitting section 4 is to be irradiated, in accordance with a driving condition of the automobile 10. This allows the automobile 10 to project with the use of an arbitrary projection pattern during the driving of the automobile 10. This ultimately allows the convenience of a user to be enhanced.

### [Application Examples of the Present Invention]

The light emitting device in accordance with the present invention can be applied not only to a headlight for a vehicle but also to other illumination devices. Examples of the illumination device in accordance with the present invention include a downlight. The downlight refers to an illumination device arranged on a ceiling of a structure such as a house or vehicle. The illumination device in accordance with the present invention can be implemented (i) as a head lamp of a movable object (such as a human, a ship, an aircraft, a submarine, or a rocket) other than a vehicle or (ii) as a room light fixture (such as a desk lamp) other than a search light, a projector and a downlight.

### [A Light Emitting Section 4 Whose Mounting Location can be Shifted]

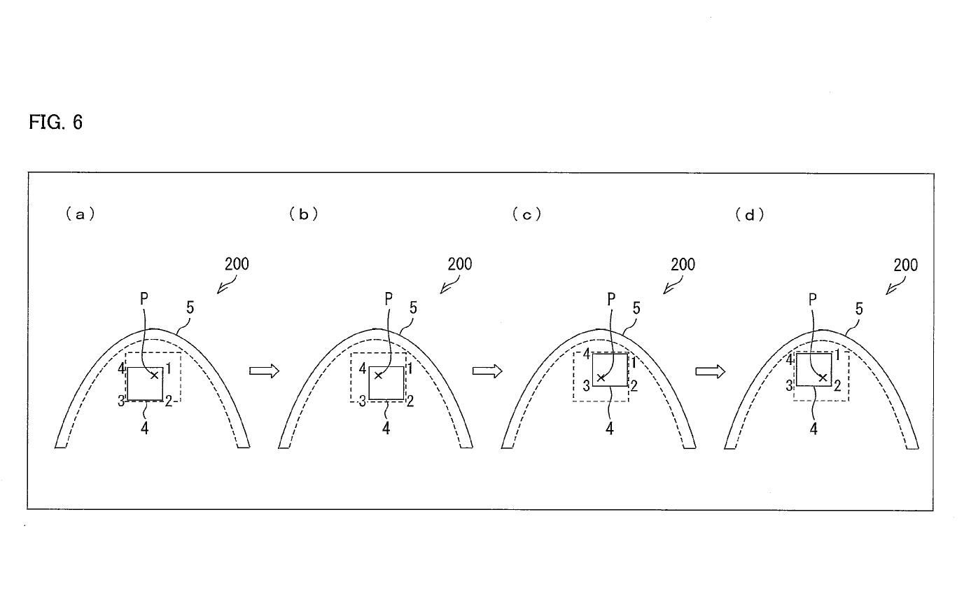

The following description will discuss a head lamp 200 in accordance with another example of the present embodiment with reference to FIG. 6 and other drawings. Note that the contents, which have already been described with reference to FIG. 1 and other drawings, will be omitted here.

(a) through (d) of FIG. 6 are top views schematically illustrating the head lamp 200. (a) of FIG. 6 illustrates a situation in which the head lamp 200 is arranged in a first location, and (b) of FIG. 6 illustrates a situation in which the head lamp 200 is arranged in a second location. (c) of FIG. 6 illustrates a situation in which the head lamp 200 is arranged in a third location, and (d) of FIG. 6 illustrates a situation in which the head lamp 200 is arranged in a fourth location. In (a) through (d) of FIG. 6, a point P indicates a focal point of the parabolic mirror 5 and the numbers (1 through 4), indicated at the respective corners of the light emitting section 4, indicate the corner numbers of the light emitting section 4 having a square shape.

As illustrated in (a) of FIG. 6, the focal point P is located near a corner 1 of the light emitting section 4. As is illustrated in (b) of FIG. 6, the focal point P is located near a corner 4 of the light emitting section 4. As is illustrated in (c) of FIG. 6, the focal point P is located near a corner 3 of the light emitting section 4. As is illustrated in (d) of FIG. 6, the focal point P is located near a corner 2 of the light emitting section 4. That is, the light emitting section 4 of the head lamp 200 is arranged so that the focal point P of the parabolic mirror 5 is located in a region where the light emitting section 4 is located. Note, however, that the location where the light emitting section 4 is located can be moved (displaced) within a region indicated by the dotted line illustrated in (a) through (d) of FIG. 6. The configuration can be attained by an configuration in which the light emitting section 4 can be screwed to the metal base 7 in any of the four locations (the first through fourth locations) as illustrated, for example, (a) through (d) of FIG. 6.

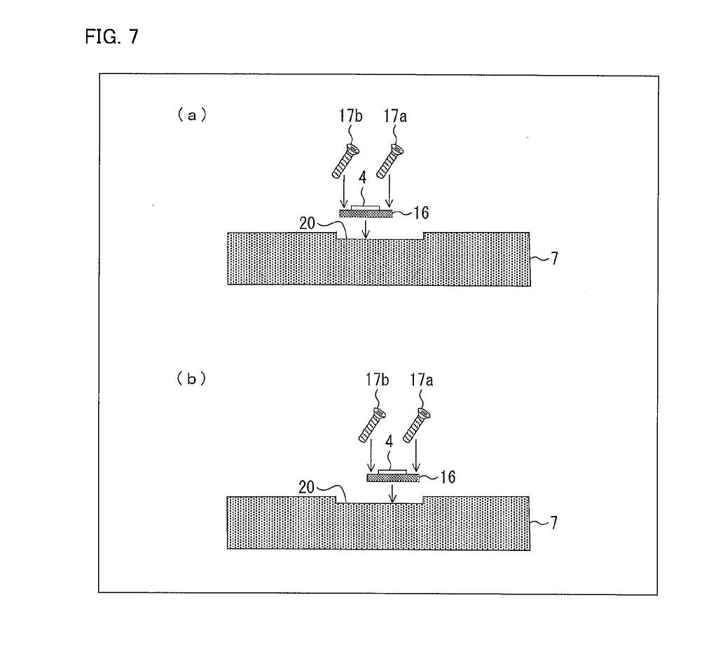

(a) and (b) of FIG. 7 illustrate configurations in each of which the light emitting sections 4 is to be mounted on the metal base 7. That is, FIGS. 7(a) and 7(b) illustrate how to mount the light emitting section 4 on the metal base 7. (a) of FIG. 7 illustrates a configuration in which the light emitting section 4 is mounted in a first location of the metal base 7, and (b) of FIG. 7 illustrates a configuration in which the light emitting section 4 is mounted in a second location of the metal base 7.

According to the configuration described with reference to (a) through (d) of FIG. 6, the location where the light emitting section 4 is located can be moved (displaced) within a region indicated by the dotted line. This prevents focal points of the parabolic mirror 5 from being fixed on a specific point of the light emitting section 4. It is therefore possible to protect the light emitting section 4 against deterioration. As a result, the head lamp 200 can be used over an extended period of time.

FIG. 6 illustrates a case where the light emitting section 4 has a square shape. However, the light emitting section is not limited to a specific shape, and can therefore have a shape such as a circle, a polygon, a pentagram, or a rectangle.

Particularly, in a case where the head lamp 200 is used as a head lamp for an automobile, the automobile is preferably managed so that a mounting location of the light emitting section 4 is regularly shifted from one of the four locations to the next, for example, during an automobile inspection and/or a periodic inspection. With the management, it is possible to change a location where laser light is excited in the light emitting section 4. This (i) allows a user to use the head lamp 200 without worrying about reduction in brightness due to long-term use and (ii) can help a user drive safely at night.

Note that the way to shift the mounting location of the light emitting section 4 is not limited to the manual operation. Therefore, the mounting location can be automatically shifted with the use of a machine. For example, the mounting location can be automatically shifted by means of a mounting location shift section for shifting a mounting location after a predetermined period of time has elapsed.

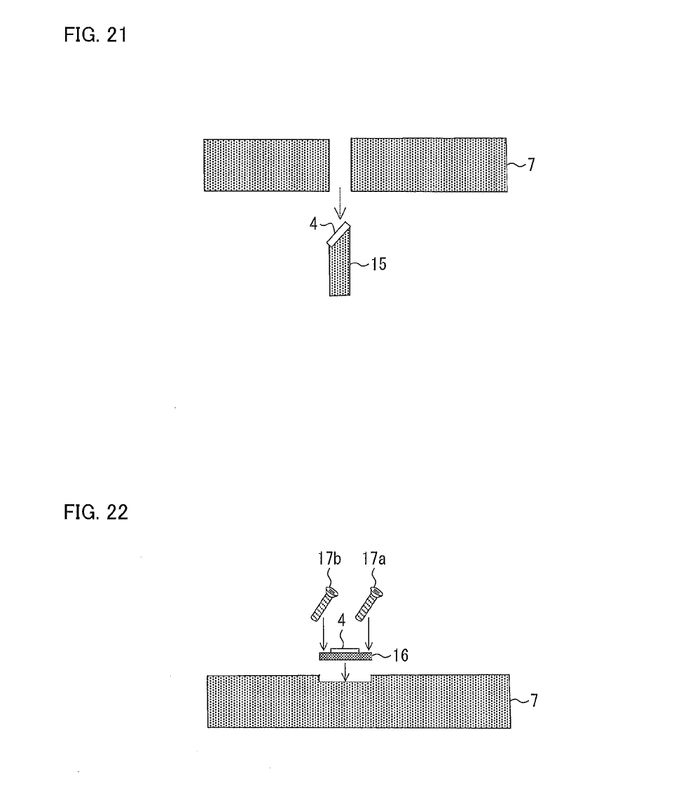

Further, in a case of the head lamp 200 which has been described with reference to FIG. 6, the mounting location can be changed at least 4 times until the light emitting section 4 is replaced with a new one. Until the light emitting section 4 is replaced with a new one, a user can continue to use the head lamp 200 without reduction in light intensity. Accordingly, a user can use the head lamp 200 longer than a head lamp 950 which will be described (later) with reference to FIG. 22 and other drawings, without reduction in light intensity.

FIG. 6 shows that there are four mounting locations of the light emitting section 4. Note, however, that the number of the mounting locations is not limited to four, and can therefore be any number. The more the number of the mounting locations is, the longer a user can use the head lamp 200 without reduction in light intensity.

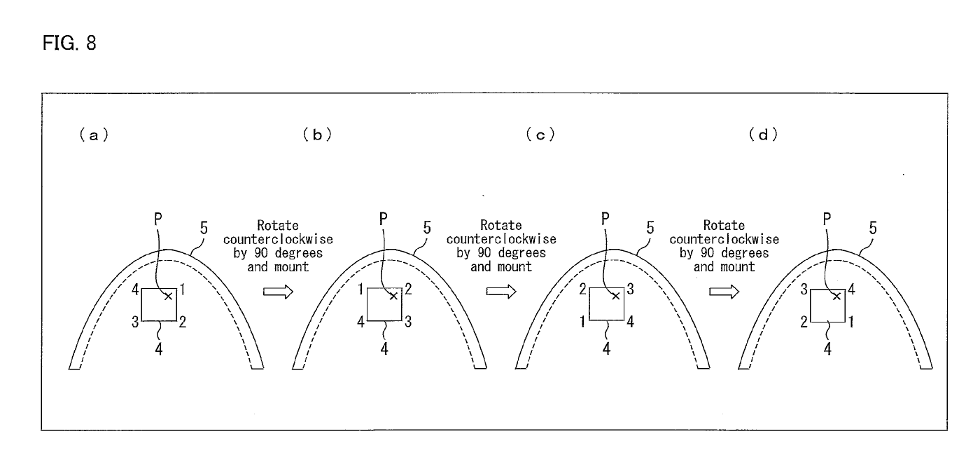

Another configuration for attaining the light emitting section 4 whose mounting locations can be shifted will be described with reference to (a) through (d) of FIG. 8. (a) through (d) of FIG. 8 are views illustrating how to change an angle where a light emitting section 4 having a square shape is provided.

(b) of FIG. 8 illustrates a situation in which the light emitting section 4 illustrated in (a) of FIG. 8 is rotated counterclockwise by 90 degrees. (c) of FIG. 8 illustrates a situation in which the light emitting section 4 illustrated in (b) of FIG. 8 is rotated counterclockwise by 90 degrees. (d) of FIG. 8 illustrates a situation in which the light emitting section 4 illustrated in (c) of FIG. 8 is rotated counterclockwise by 90 degrees. Since the mounting angle of the light emitting section 4 is thus changed (displaced), (i) it is possible to prevent focal points of the parabolic mirror 5 from being fixed on a specific point of the light emitting section 4. It is therefore possible to protect the light emitting section 4 against deterioration. As a result, the head lamp can be used over an extended period of time.

(a) through (d) of FIG. 8 illustrate a case where the light emitting section 4 has a square shape. However, the light emitting section is not limited to a specific shape, and can therefore have a shape such as a circle, a polygon, a pentagram, or a rectangle.

Note that, in FIG. 8, the light emitting section 4 is rotated parallel to a surface on the metal base 7 on which surface the light emitting section 4 is to be mounted. However, it is not essential that the light emitting section be rotated absolutely parallel to the surface on the metal base 7 on which surface the light emitting section is to be mounted. It is essential that the light emitting section 4 be rotated so that a position irradiated with laser light is changed on an irradiated surface of the light emitting section 4 (so that the position irradiated with laser light is changed into a different position on the light emitting section 4).

Particularly, in a case where the head lamp is used as a head lamp for an automobile, the automobile is preferably managed so that a mounting angle of the light emitting section 4 is regularly shifted, for example, during an automobile inspection and/or a periodic inspection. With the management, it is possible to change a position of the light emitting section 4 which position is excited with laser light. This (i) allows a user to use the head lamp without worrying about reduction in brightness due to long-term use, and (ii) can help a user drive safely at night.

Note that the way to change the mounting angle of the light emitting section 4 is not limited to the manual operation. Therefore, the mounting angle can be automatically changed with the use of a machine. For example, the mounting angle can be automatically changed by means of a mounting angle shift section for changing a mounting angle after a predetermined period of time has elapsed.

### [A Movable Light Emitting Section 4]

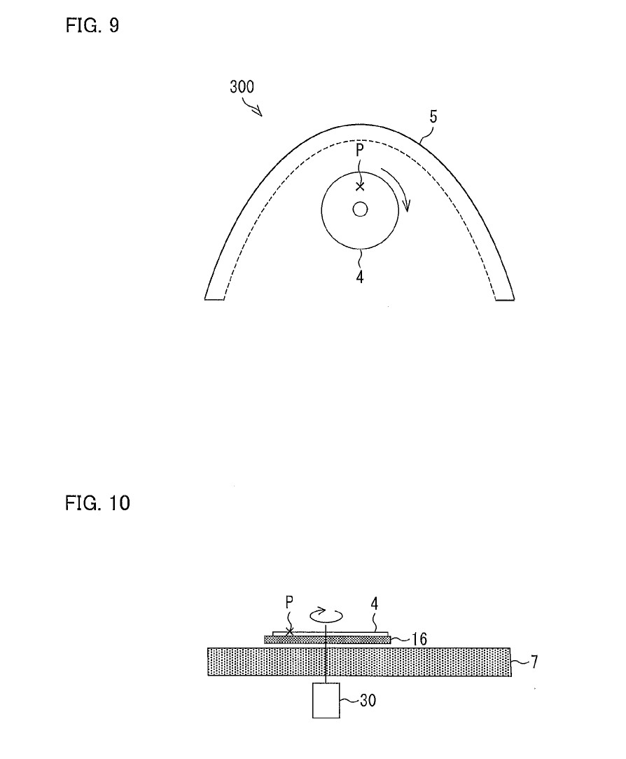

The following description will discuss a head lamp 300 in accordance with a further example of the present embodiment with reference to FIG. 9 and other drawings. Note that the contents which have already been described with reference to FIG. 1 and other drawings will be omitted here.

FIG. 9 is a top view schematically illustrating the head lamp 300. In the head lamp 300, a light emitting section 4 having a ring shape is provided so that a focal point P of a parabolic mirror 5 is located in a region where the light emitting section 4 is located. A metal member, which supports the light emitting section 4, is connected to a motor (not illustrated) so as to be rotated (displaced) in a direction indicated by an arrow in FIG. 9 in response to rotation of the motor.

The above configuration will be more specifically described below with reference to FIG. 10. FIG. 10 is a side view of the head lamp 300. In the head lamp 300, a metal member (support member) 16 is provided above the metal base 7. The metal member 16 supports the light emitting section 4. Below the metal base 7, a motor (operating device) 30 is provided, which is connected to the metal member 16. The metal member 16 is thus rotated in a direction indicated by the arrow in FIG. 9 in response to rotation of the motor 30. The rotational speed is not necessarily high and can be, for example, about 1 Hz to 200 Hz.

The head lamp 300 having the above-described configuration brings about the following advantage. Specifically, in a case of the head lamp 300, the light emitting section 4 is supported by the metal base 7 which always rotates in response to rotation of the motor 30. This allows focal points of the parabolic mirror 5 to be dispersed without being fixed on a specific point of the light emitting section 4. It is therefore possible to protect the light emitting section against deterioration. As a result, the head lamp 300 can be used over an extended period of time.

If the head lamp 300 is used as a head lamp for an automobile, then no deterioration occurs in a specific location on the light emitting section 4. This causes an extreme slow reduction in brightness due to long-term use. This can help a user drive safely at night.

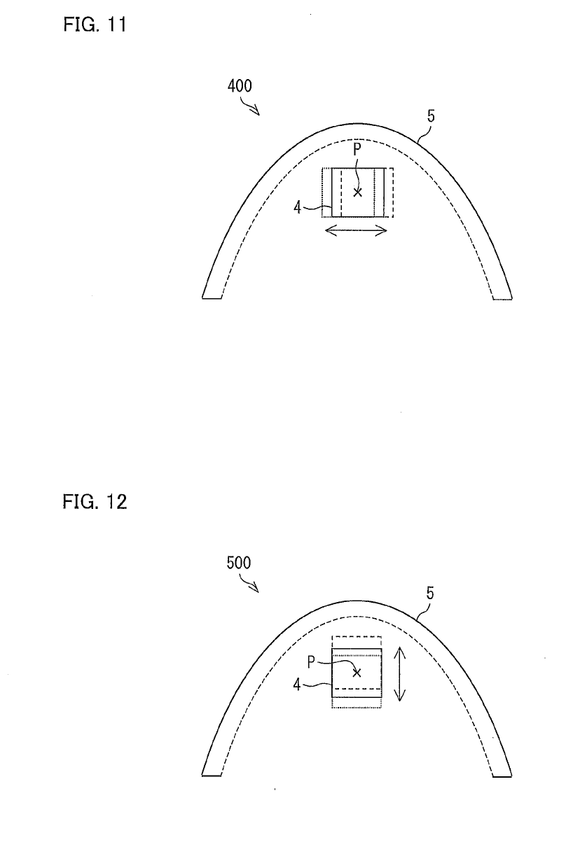

The following description will discuss a head lamp 400 in accordance with still a further example of the present embodiment with reference to FIG. 11 and other drawings. Note that the contents which have already been described with reference to FIG. 1 and other drawings will be omitted here.

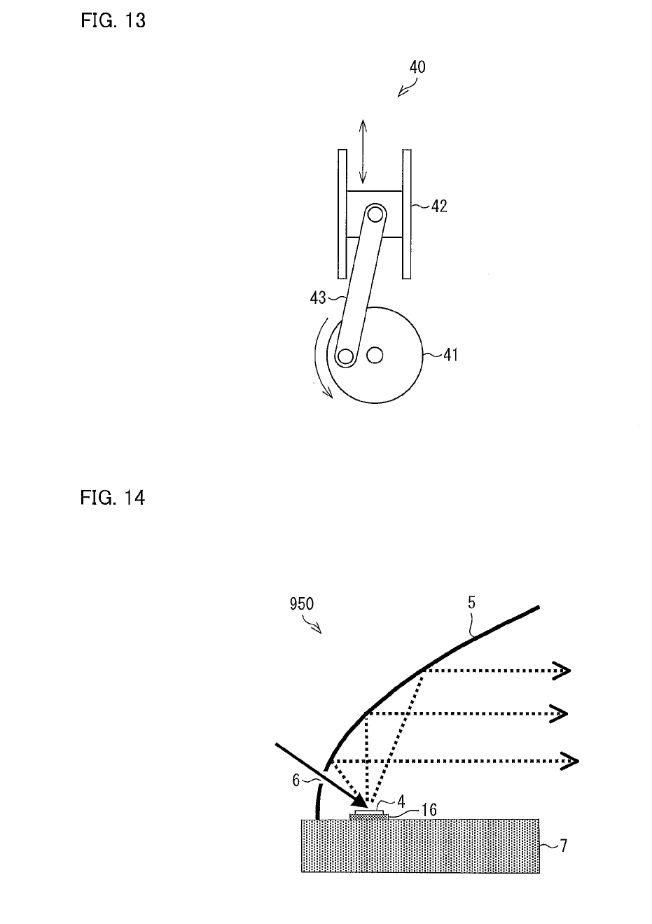

FIG. 11 is a top view schematically illustrating the head lamp 400. And, FIG. 12 is a top view schematically illustrating a head lamp 500. As illustrated in FIG. 11, the light emitting section 4 of the head lamp 400 is reciprocated (displaced) in a horizontal direction in FIG. 11. On the other hand, the light emitting section 4 of the head lamp 500 is reciprocated in a vertical direction in FIG. 12. The reciprocation will be described with reference to FIG. 13.

FIG. 13 is a diagram illustrating a crank mechanism 40 for causing the light emitting section 4 of the head lamp 400 or 500 to reciprocate.

The crank mechanism 40 includes a crank disc 41, a slider 42, and a connecting rod 43. The crank disc 41 interlocks with, for example, a power supply of the head lamp 400 or 500 so as to make a rotational motion. The rotational motion of the crank disc 41 is transmitted to the slider 42 via the connecting rod 43. In this case, the rotational motion of the crank disc 41 is transmitted, as reciprocation, to the slider 42. It is therefore possible, by interlocking the light emitting section 4 to the slider 42, to convert the reciprocation of the crank disc 41 into reciprocation of the light emitting section 4 in a lateral or longitudinal direction.

In the head lamps 400 and 500, which have the above-mentioned configuration, it is possible to disperse positions irradiated with excitation light emitted by the laser element 2 without fixing on a specific point of the light emitting section 4. This allows deterioration of the light emitting section 4 to be suppressed. As the result, the head lamp can be used over an extended period of time.

Although the examples have described the motor 30 and the crank mechanism 40, the present embodiment is not limited to these examples. Another example is also conceivable in which a metal base 7 itself, on which the light emitting section 4 is provided, can move to and fro. A further example is conceivable in which the light emitting section 4, fixed on the metal base 7 by, for example, a spring which expands and contracts in an arbitrary direction, is moved in an arbitrary direction in response to elastic motion of the spring. Still a further example is conceivable in which a movement of the light emitting section 4 is precisely controlled by a program such that an entire surface of the light emitting section 4 is uniformly irradiated with laser light. In other words, the present embodiment encompasses various examples having a technical concept for dispersing positions irradiated with excitation light emitted from the laser element 2 without fixing on a specific point of the light emitting section 4.

### [Reflective/Transmissive Head Lamp]

The present embodiment has been directed to the head lamp including a configuration (hereinafter, referred to as a “reflective light emitting section”) for emitting laser light toward the light emitting section 4 via the parabolic mirror 5. Hereinafter, a head lamp including a reflective light emitting section is referred to as a reflective head lamp. According to the reflective head lamp, the light emitting section 4 is irradiated with laser light via the parabolic mirror 5, so as to emit fluorescence on its surface irradiated with the laser light. The fluorescence emitted from the light emitting section 4 is reflected by the parabolic mirror 5, and is then directed to outside the head lamp.

Note, however, that the present embodiment can be applied to another head lamp including a configuration (hereinafter, referred to as a “transmissive light emitting section”) for emitting, directly or via a transparent member, laser light toward the light emitting section 4. Hereinafter, a head lamp including the transmissive light emitting section is referred to as a transmissive head lamp. According to the transmissive head lamp, the light emitting section 4 is irradiated with laser light via the metal base 7, so as to emit fluorescence on its surface opposite to the surface irradiated with the laser light (a surface of the light emitting section 4 which surface faces the parabolic mirror 5). The fluorescence emitted from the fluorescence section 4 is reflected by the parabolic mirror 5, and is then directed to outside the head lamp.

The present embodiment is not limited to the configuration in which the light emitting section 4 is provided on the metal member 16. The present embodiment can include a configuration in which no metal member 16 is provided. Particularly, in a case of the transmissive light emitting section, such a configuration is also possible that the light emitting section 4 is provided on a transparent member (support member) 25. These examples will be described below with reference to FIGS. 14 through 17.

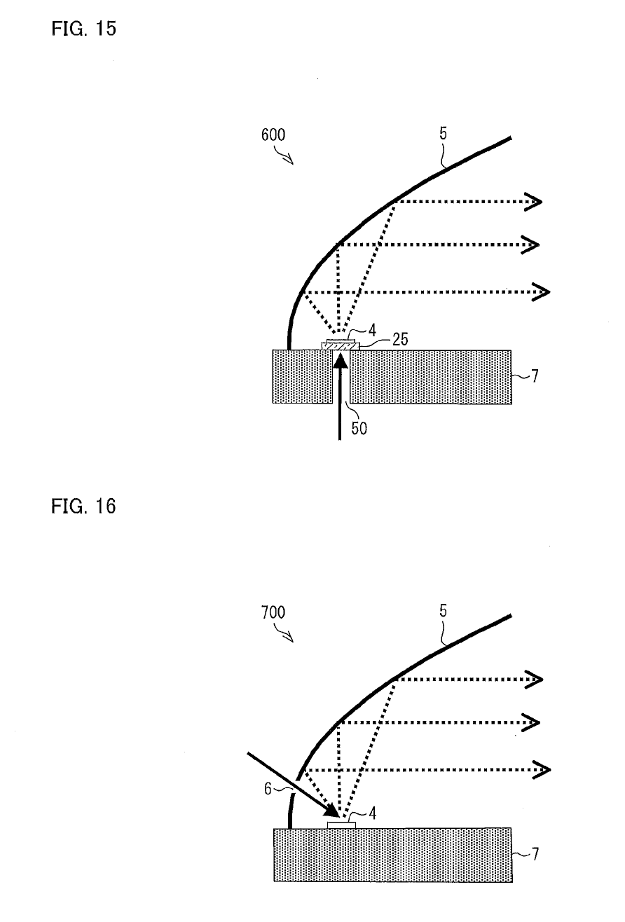

FIG. 14 is a side view schematically illustrating a reflective head lamp 950. FIG. 15 is a side view schematically illustrating a transmissive head lamp 600. FIG. 16 is a side view schematically illustrating a reflective head lamp 700 which uses no metal member. FIG. 17 is a side view schematically illustrating a transmissive head lamp 800 which uses no transparent member.

In the head lamp 600 of FIG. 15, the light emitting section 4 is provided on a transparent member 25. The transparent member 25 is preferably made from a material having excellent thermal conductivity and high transmittance with respect to laser wavelength. Examples of the transparent member 25 include a glass. The metal base 7 has an opening 50. Laser light passes through the opening 50 and is then transmitted by the transparent member 25, so as to enter the light emitting section 4.

The head lamp 700 of FIG. 16 is a reflective head lamp in which the light emitting section 4 is directly provided on the metal base 7.

In the head lamp 800 of FIG. 17, the light emitting section 4 is provided directly on the metal base 7 without the transparent member 25 being interposed. The light emitting section 4 is irradiated with laser light which has passed through the opening 50 formed in the metal base 7.

The light emitting sections 4 in FIGS. 16 and 17 are prepared by sintering a fluorescent material into a plate. The light emitting section 4 is fixed on the metal base 7 with the use of springs or press tools. Alternatively, the light emitting section 4 can be configured to be connected to a motor 30 or a crank mechanism 40 (not illustrated in these figures). This makes it possible (i) for the light emitting section 4 to be provided so that the focal point of the parabolic mirror 5 is located in the light emitting section 4 and (ii) to change the relative location between (a) a surface of the light emitting section 4 which surface is irradiated with laser light and (b) the focal point of the parabolic mirror 5.

The present embodiment can be applied to both types of the reflective and transmissive head lamps. Further, the head lamp in accordance with the present embodiment can provide a device whose light emitting performance is kept, irrespective of whether the metal member 16 and the transparent member 25 are provided. Accordingly, it is possible to use the light emitting section 4 over an extended period of time.

### [A Light Emitting Section 4 Which is Replaceable]

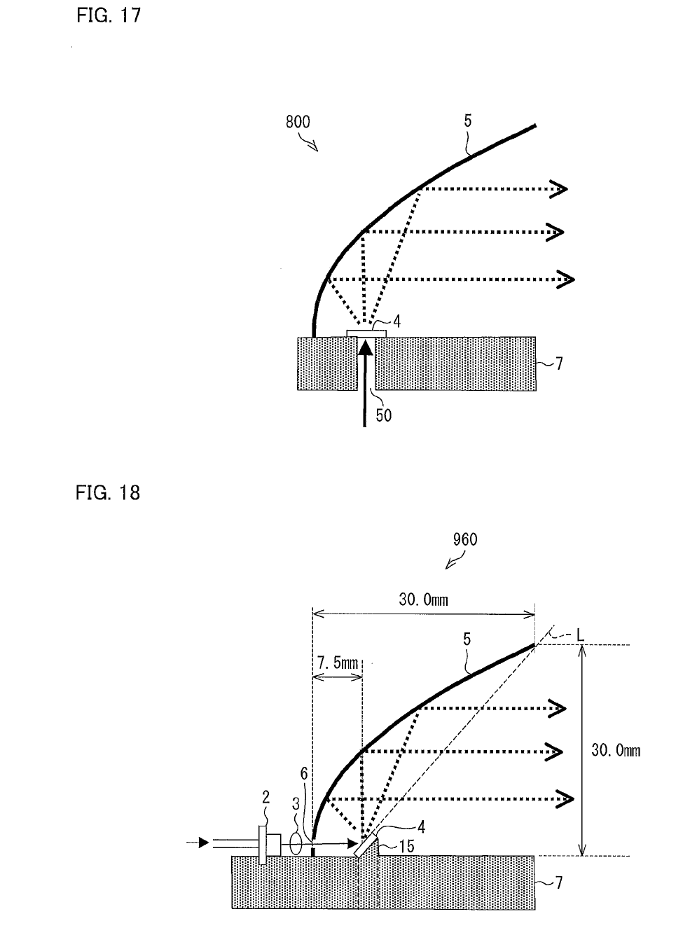

The following description will discuss the head lamp 960, which is an example of the present embodiment, with reference to FIG. 18 and other drawings. Note that the contents which have already been described with reference to FIG. 1 and other drawings will be omitted here.

FIG. 18 is a side view illustrating the head lamp 960 in accordance with the present example. The head lamp 960 includes three laser elements 2. Each of the three laser elements 2, which is mounted in a metal package of Φ9 mm, outputs laser light of 2 W having a wavelength of 405 nm. The light emitting section 4 is irradiated, from three directions, with laser light emitted from the three laser elements 2. In this case, the laser light is converged onto an area of Φ1 mm on the light emitting section 4 via respective condenser lenses 3.

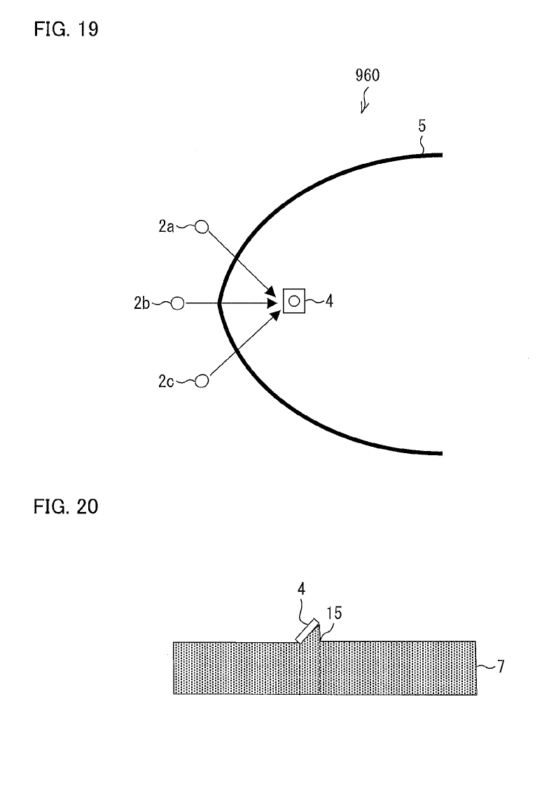

FIG. 19 is a top view schematically illustrating the head lamp 960 in which the light emitting section 4 is irradiated, from three directions, with the laser light emitted from the laser elements 2. From the top of FIG. 19, a laser element 2a, a laser element 2b, and a laser element 2c are provided in this order. An area of Φ1 mm on the light emitting section 4 (a section of the light emitting section 4 having a circle shape in FIG. 19) is intensively irradiated with the laser light emitted from the laser element 2a, the laser element 2b and the laser element 2c.

The parabolic mirror 5 is obtained by applying aluminum onto an interior surface of a resin parabolic mirror. A front opening of the parabolic mirror 5 has (i) a shape of a half circle having a radius of 30 mm and (ii) a depth of 30 mm.

In the light emitting section 4, three types of fluorescent materials, i.e., RGB fluorescent materials, are mixed, so that white light is emitted from the light emitting section 4. In this case, the red fluorescent material is CaAlSiN₃:Eu, the green fluorescent material is β-SiAlON:Eu, and the blue fluorescent material is (BaSr)MgAl₁₀O₁₇:Eu. The light emitting section 4 is configured to be a thin film having a thickness of 0.1 mm. The light emitting section 4 is prepared by (i) mixing powders of the fluorescent materials with the transparent resin and then applying such a mixture onto the surface of the metal base 7. The light emitting section 4 is provided so that the focal point of the parabolic mirror 5 is located near the center of a surface of the light emitting section 4 which surface is to be irradiated with laser light. That is, the laser element 2 excites, with laser light, a part which corresponds to the focal point of the parabolic mirror 5.

Further, the light emitting section 4 is provided at a certain angle to a surface of the metal base 7 so that the outermost edge of the opening of the parabolic mirror 5 is an extension (a line L in FIG. 18) of the irradiated surface of the light emitting section 4. This makes it possible to reduce the glare or dazzle which may be caused when the light emitting section 4 is viewed from outside. This is because a light emitting point in the light emitting section 4 is not directly viewed from the outside of the metal base 7. Furthermore, the arrangement of the light emitting section 4 allows the fluorescence, emitted from the light emitting section 4, to be reflected efficiently and without waste by the parabolic mirror 5.

The metal base 7 is made from a material having a high heat radiation efficiency such as aluminum. The metal base 7 also functions as radiating heat generated by the laser and the light emitting section 4.

Further, the head lamp 960 is configured such that a light emitting section 4, which has been used for a predetermined period of time, can be replaced with a new light emitting section 4. The replacement will be described with reference to FIGS. 20 and 21.

FIG. 20 shows that a metal member (support member) 15 on which upper part the light emitting section 4 is applied is attached to the metal base 7. FIG. 21 shows that the metal member 15 is detached from the metal base 7.

As illustrated in both FIGS. 20 and 21, the light emitting section 4, together with the metal member 15 onto which the light emitting section 4 is applied, is configured to be easily detached from the metal base 7 and to be replaceable with a new metal member 15 onto which a new light emitting section 4 is applied. Since a light emitting section 4 is configured to be replaceable with a new one (a metal member 15 onto which a light emitting section 4 is applied) every time the light emitting section 4 has been used (emitted) over a predetermined period of time of use, the head lamp 960 can be used over an extended period of time while compensating reduction in brightness.

The material of the metal member 15 is not particularly limited but preferably the same material as that of the metal base 7 to which the metal member 15 is attached. This makes it possible to prevent bimetallic corrosion which may be caused by different types of metal materials contacting electrically with each other.

The following description will discuss, with reference to FIG. 22, another configuration for attaining a replaceable light emitting section 4, in which only the light emitting section 4 is replaced with a new one. FIG. 22 illustrates how to replace a light emitting section 4 with a new one via screws.

As illustrated in FIG. 22, the light emitting section 4 is provided on a metal member 16 having a plate shape. The metal member 16 is fitted into a recessed part of a metal base 7 and is then fixed on the metal base 7 with the use of screws 17a and 17b. Note that the metal member 16 can be fixed on the metal base 7 with the use of adhesive or solder, in addition to or instead of the screws. According to the configuration, a light emitting section can be easily replaced with a new one.

The following description will discuss, with reference to FIG. 23, yet another configuration for attaining a replaceable light emitting section 4. FIG. 23 illustrates how to replace a light emitting section 4 with a new one by being fitted into a metal base 7.

As illustrated in FIG. 23, the light emitting section 4 is provided on a metal member 18 having a rod shape. The metal member 18 is fitted into (or screwed in) an opening formed in the metal base 7 and is then fixed on the metal base 7. The metal member 18 can be fixed on the metal base 7 with the use of adhesive or solder, in addition to or instead of the fitting. According to the configuration, a light emitting section can be easily replaced with a new one.

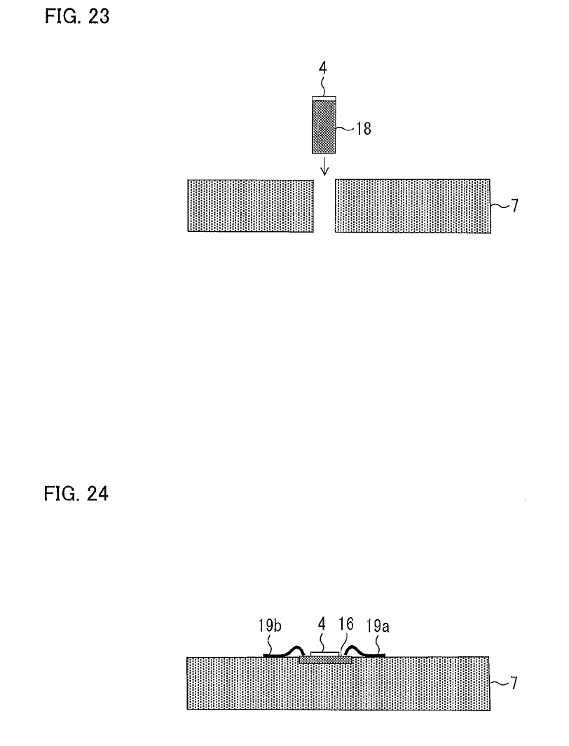

The following description will discuss, with reference to FIG. 24, a further configuration for attaining a replaceable light emitting section 4. FIG. 24 illustrates how to replace a light emitting section 4, provided with the use of springs, with a new one.

As illustrated in FIG. 24, the light emitting section 4 is provided on a metal member 16 having a plate shape. The metal member 16 is fitted into a recessed part of a metal base 7 and is then fixed on the metal base 7 by being pressed by springs 19a and 19b. The metal member 16 can be fixed on the metal base 7 with the use of adhesive, solder or by fitting, in addition to or instead of being pressed by springs. According to the configuration, a light emitting section can be easily replaced with a new one.

According to the configurations described with reference to respective FIGS. 22 through 24, a light emitting section 4 can be easily detached from the metal base 7 and easily replaced with a new light emitting section.

In a case where the head lamp 960 is used as a head lamp for an automobile, the automobile is preferably managed so that the used light emitting section 4 is replaced with a new light emitting section, for example, during automobile inspection and/or a periodic inspection. The management (i) allows a user to use the head lamp 950 without worrying about reduction in brightness due to long-term use and (ii) can help a user drive safely at night. A color tone (color temperature) of the material of the fluorescence section can be freely selected in accordance with the user's preference, within the regulation.

Of course, a configuration, in which a light emitting section 4 can be replaced with a new light emitting section, is not limited to the above-described configurations, and therefore can be any of other configurations.

### [Modifications]

The following description will discuss various modifications encompassed in the present embodiment.

According to the description of the head lamp 1 and the like, the parabolic mirror 5 is used as a reflecting mirror. In the present embodiment, however, the shape of the reflecting mirror is not limited to this. For example, the reflecting mirror can be a circle mirror, an elliptic mirror, a free-form curved-surface mirror, or multifaceted mirrors. Further, a projection lens can be used as a projector means.

Furthermore, the present embodiment is neither limited to a specific wavelength of laser light generated by the laser element 2 nor a specific method for converging the laser light. For example, the wavelength of the laser light is not limited to 405 nm and can therefore be 450 nm or other wavelength. The method for converging the laser light can be a method for collecting light with the use of a lens, a wedge-shaped waveguide parts, or a concave mirror. Furthermore, the present embodiment is also not to be limited to a specific type of the fluorescent material, a specific shape of the light emitting section, and a specific color of light emitted from the light emitting section.

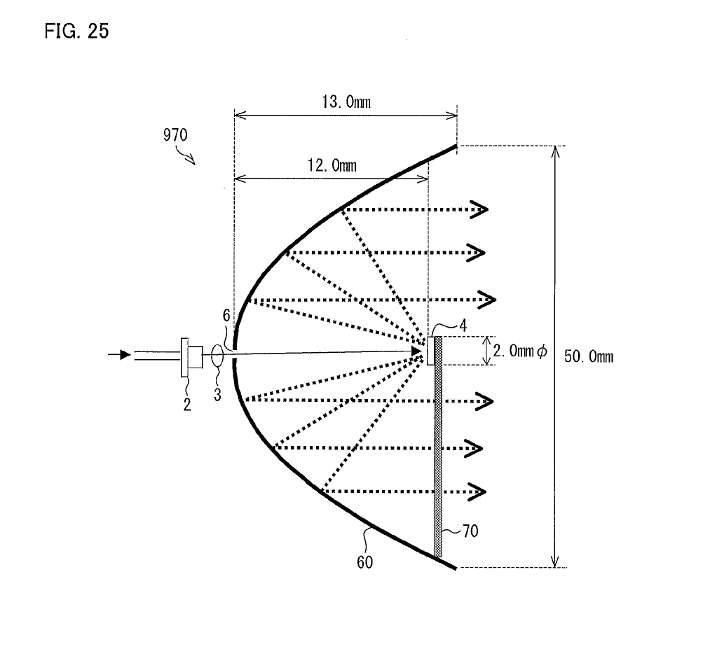

An example will be described with reference to FIG. 25. FIG. 25 is a top view schematically illustrating a head lamp 970.

The head lamp 970 includes two laser elements 2 (for convenience, only one laser element 2 is illustrated in FIG. 25). Each of the two laser elements 2, mounted in a metal package of Φ9 mm, outputs laser light of 2 W having a wavelength of 405 nm. In this case, the laser light emitted from the laser elements 2 is converged onto an area of Φ1 mm on the light emitting section 4 via a condenser lens 3.

A reflector 60 is obtained by applying aluminum onto an interior surface of a resin parabolic mirror. The front opening of the reflector 60 has (i) a shape of a circle having a diameter of 50 mm and (ii) a depth of 13 mm.

In the light emitting section 4, three types of fluorescent materials, i.e., RGB fluorescent materials, are mixed, so that white light is emitted from the light emitting section 4. In this case, the red fluorescent material is CaAlSiN₃:Eu, the green fluorescent material is β-SiAlON:Eu, and the blue fluorescent material is (BaSr)MgAl₁₀O₁₇:Eu. The light emitting section 4 is configured to be a thin film of Φ2 mm having a thickness of 0.1 mm. The light emitting section 4 is prepared by (i) mixing powders of the fluorescent materials with the transparent resin and then applying such a mixture onto the surface of the metal base 7. The light emitting section 4 is provided so that the focal point of the reflector 60 is located near the center of a surface of the light emitting section 4 which surface is to be irradiated with laser light. That is, the laser element 2 excites, with laser light, a part which corresponds to the focal point of the reflector 60. The light emitting section 4 is provided on a metal member (not illustrated), which is supported by a metal post 70. The depth from the window 6 to the surface of the light emitting section 4 which surface is to be irradiated with the laser light is 12 mm. The metal post 70, which is supported by the reflector 60, serves as heat dissipation from the light emitting section 4.

Since the metal post 70, on which the metal member is provided, is replaceable after a predetermined period of time has elapsed, the head lamp 970 can be used over an extended period of time without being influenced by deterioration of the light emitting section 4.

The present invention is not limited to the above-mentioned embodiments, and various modifications are possible within a scope defined by Claims. The technical scope of the present invention encompasses embodiments obtained by appropriately combining the technical means disclosed in different embodiments.

### [Different Way of Description of the Present Invention]

The present invention can also be described in a different way as follows.

In order to solve the above-mentioned problem, a light emitting device in accordance with the present invention includes a light emitting section for emitting light upon receipt of excitation light from an excitation light source, a position on the light emitting section which position is irradiated with the excitation light being changed by displacing the light emitting section in response to reciprocation of an operating device.

With the above configuration, the light emitting section is displaced in response to the reciprocation of the operating device. The displacement of the light emitting section results in changing a position on the light emitting section which position is irradiated with excitation light. This allows a deterioration of the light emitting section to be suppressed.

The reciprocation is not limited to one caused by a specific mechanism and can therefore be one caused by a general equipment or apparatus, such as a crank mechanism or a piston mechanism.

The light emitting device in accordance with the present invention further includes a support member for supporting the light emitting section, the light emitting section being replaceable with a new one by replacement of the support member.

Generally, in a light emitting device, a light emitting section is supported by a support member. Therefore, in the light emitting device in accordance with the present invention, the used light emitting section can be replaced with a new one by replacement of the support member. It is thus possible to replace the light emitting section more quickly and easily, and in line with the actual usage.

The light emitting device in accordance with the present invention includes a reflecting mirror for reflecting the light emitted from the light emitting section, a focal point of the reflecting mirror or a position near the focal point being irradiated with the excitation light.

According to the above configuration, the position irradiated with the excitation light is located in or near the focal point of the reflecting mirror. Accordingly, on the assumption that the position irradiated with the excitation light is fixed, the position on the light emitting section which position is irradiated with the excitation light is changed by moving (displacing) the light emitting section relative to the position irradiated with the excitation light. This makes is possible to suppress deterioration of the light emitting section.

In the light emitting device in accordance with the present invention, the excitation light source can be a laser light source for emitting laser light.

In a case where the excitation light is laser light, the light emitting section is more likely to deteriorate by high output and high light density laser light from the laser light source. The light emitting device in accordance with the present invention, which particularly emits laser light from the excitation light source, has an effect that deterioration of the light emitting section can be suppressed.

In the light emitting device in accordance with the present invention, the light emitting section can be configured to contain at least a fluorescent material for emitting fluorescence upon receipt of the excitation light.

A headlight for a vehicle in accordance with the present invention can be configured to include the above-mentioned light emitting device.

An illumination device in accordance with the present invention can be configured to include the above-mentioned light emitting device.

The light emitting device in accordance with the present invention is applicable to a headlight for a vehicle, an illumination device, or the like. Accordingly, in a case where the light emitting device in accordance with the present invention is applied to, for example, a headlight for a vehicle, it is possible to attain a headlight for a vehicle which can be used over an extended period of time. This makes it possible to easily solve the early described conventional problems.

### INDUSTRIAL APPLICABILITY

The present invention (i) relates to a light emitting device which can suppress a deterioration of a light emitting section and (ii) is applicable to, in particular, a headlight for a vehicle and an illumination device.

### REFERENCE SIGNS LIST

1 Head lamp
2 Laser element (Excitation light source)
3 Condenser lens
4 Light emitting section
5 Parabolic mirror (Reflecting mirror)
7 Metal base
8 Fin
15, 16, 18 Metal member (Support member)
25 Transparent member (Support member)
17a, 17b Screw
19a, 19b Spring
30 Motor (Operating device)
40 Crank mechanism (Operating device)
60 Reflector
70 Metal post (Support member)
P Focal point

1. A light emitting device comprising:
a light emitting section for emitting light upon receipt of excitation light from an excitation light source,
the light emitting section being provided so as to be replaceable with a new one.

2. A light emitting device as set forth in claim 1, further comprising:
a support member for supporting the light emitting section,
the light emitting section being replaceable with a new one by replacement of the support member.

3. A light emitting device comprising:
a light emitting section for emitting light upon receipt of excitation light from an excitation light source,
a position on the light emitting section which position is irradiated with the excitation light being changed by changing a location or an angle where the light emitting section is provided.

4. The light emitting device as set forth in claim 1 or 3, wherein:
the excitation light source is a laser light source for emitting laser light.

5. A light emitting device as set forth in claim 1 or 3, further comprising:
a reflecting mirror for reflecting the light emitted from the light emitting section,
a focal point of the reflecting mirror or a position near the focal point being irradiated with the excitation light.

6. A light emitting device as set forth in claim 1 or 3, wherein:
the light emitting section contains at least a fluorescent material for emitting fluorescence upon receipt of the excitation light.

7. A headlight for a vehicle comprising a light emitting device recited in claim 1 or 3.

8. An illumination device comprising a light emitting device recited in claim 1 or 3.
